(19) United States
(12) Patent Application Publication
(10) Pub. No.: US 2008/0265116 A1
(43) Pub. Date: Oct. 30, 2008

(54) FOLDING DEVICE

(76) Inventor: I-Tsen CHEN, Taipei (TW)

Correspondence Address: Gibb & Rahman, LLC, Suite 304, 2568-A Riva Road, Annapolis, MD, 21401, US

(21) Appl. No.: 11/741,780

(22) Filed: Apr. 30, 2007

(51) Int. Cl. G10G 5/00

(52) U.S. Cl. 248/291.1

(57) ABSTRACT

A folding device can be mounted on a stand of an instrument stand and connect to a holder of the instrument stand to allow the holder to be folded relative to the stand and facilitate transporting the instrument stand. The folding device has a body and a pivoting bracket. The body is mounted securely with the stand and has a retaining element mounted inside. The pivoting bracket is connected with the holder and is mounted pivotally on the body. Such that the holder is foldable relative to the stand and the instrument stand may have a smaller volume when being transported, so as to conveniently transport or store the instrument stand.

### BACKGROUND OF THE INVENTION

1. Field of the Invention

The present invention relates to a folding device, and more particularly to a folding device that folds an instrument stand and facilitate transporting of the instrument stand.

2. Description of Related Art

Musical instruments are temporarily held on an instrument stand for displaying. A conventional instrument stand generally has a stand and a holder. The stand has a top, a bottom and multiple legs. The legs are formed radially from the bottom of the stand and abut the ground to support the stand. The holder is mounted securely on the top of the stand and has a pair of hooks to clamp a music instrument and therefor hold the music instrument in position.

Since the holder is securely mounted on the stand, a user can't fold the holder to facilitate transporting the stand and it may be troublesome to remove or store the instrument stand.

To overcome the shortcomings, the present invention provides a folding device to obviate or mitigate the aforementioned problems.

### SUMMARY OF THE INVENTION

The main objective of the present invention is to provide a folding device that can be mounted on a stand of an instrument stand and connect to a holder of the instrument stand and allow the holder to be folded relative to the stand and thereby facilitate transporting the instrument stand.

To achieve the objective, the folding device comprises a body and a pivoting bracket. The body is adapted to be mounted securely with a stand. The pivoting bracket is adapted to connect with a holder. The body has a retaining element mounted longitudinally inside, and the pivoting bracket is mounted pivotally on the body and is selectively retained in position by the retaining element.

With such an arrangement, the holder is able to be folded relative to the stand with the operation of the retaining element. The instrument stand may have a smaller volume and in a folded manner, such that to transport or to store the instrument stand is convenient.

Other objectives, advantages and novel features of the invention will become more apparent from the following detailed description when taken in conjunction with the accompanying drawings.

### BRIEF DESCRIPTION THE DRAWINGS

FIG. 1 is an exploded perspective view of a folding device in accordance with the present invention;

FIG. 2 is a side view of the folding device in FIG. 1 with internal components shown in broken lines;

FIG. 3 is a perspective view of the folding device in FIG. 1 mounted on an instrument stand;

FIG. 4 is an enlarged perspective view of the folding device in FIG. 3 mounted on an instrument stand;

FIG. 5 is an operational side view of the folding device in FIG. 1 with internal components shown in broken lines;

FIG. 6 is an operational side view of the folding device in FIG. 1 showing the distal end of the retaining element sliding over the end surface of the first tongue; and

FIG. 7 is an operational side view of the folding device in FIG. 1 showing the distal end of the retaining element blocked by the end surface of the second tongue.

### DETAILED DESCRIPTION OF THE PREFERRED EMBODIMENT

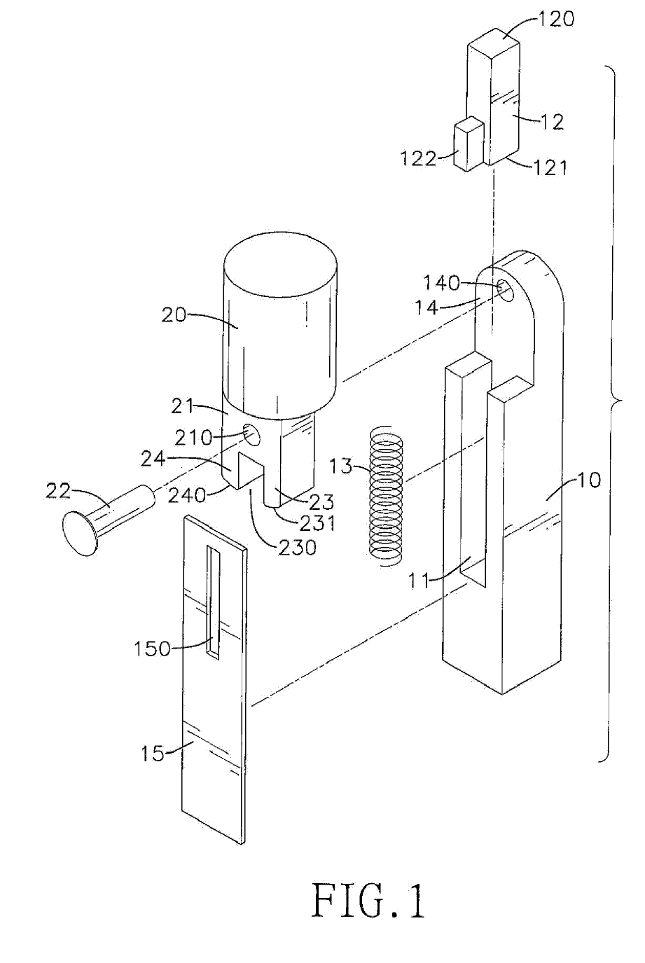

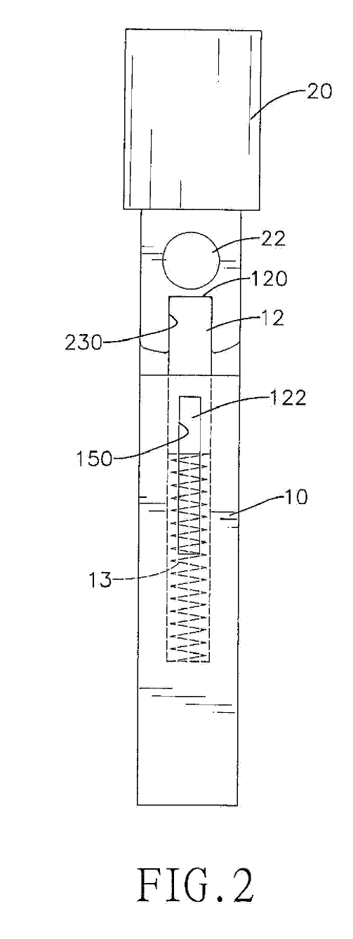

With reference to FIGS. 1, 2, 5 and 6, a folding device in accordance with the present invention comprises a body (10), a pivoting bracket (20) and a bolt (22).

The body (10) has a side surface, a bottom end, a top end, a receiving notch (11), an extending portion (14), a resilient element (13), a cover (15) and a retaining element (12). The receiving notch (11) is formed longitudinally in the side surface of the body (10) and has an opening formed in the top end of the body (10). The extending portion (14) is longitudinally protruding from the top end of the body (10) besides the opening of the receiving notch (11) and has two side edges and a through hole (140) formed transversely through the extending portion (14). The resilient element (13) may be a spring, is mounted longitudinally in the receiving notch (11) and has two ends. The cover (15) is mounted securely on the side surface of the body (10) and has a slot (150). The slot (150) is formed longitudinally through the cover (15), communicate with the receiving notch (11) and has a length. The retaining element (12) is mounted inside the receiving notch (11) near the opening and has a side surface, a proximal end (121), a distal end (120) and a protrusion (122). The proximal end (121) abuts one end of the resilient element (13) and the distal end (120) protrudes out from the opening of the receiving notch (11). The protrusion (122) is formed transversely on the side surface and extends through the slot (150) of the cover (15), such that a user can drag the retaining element (12) to make the retaining element (12) draw back into the receiving notch (11) and compress the resilient element (13).

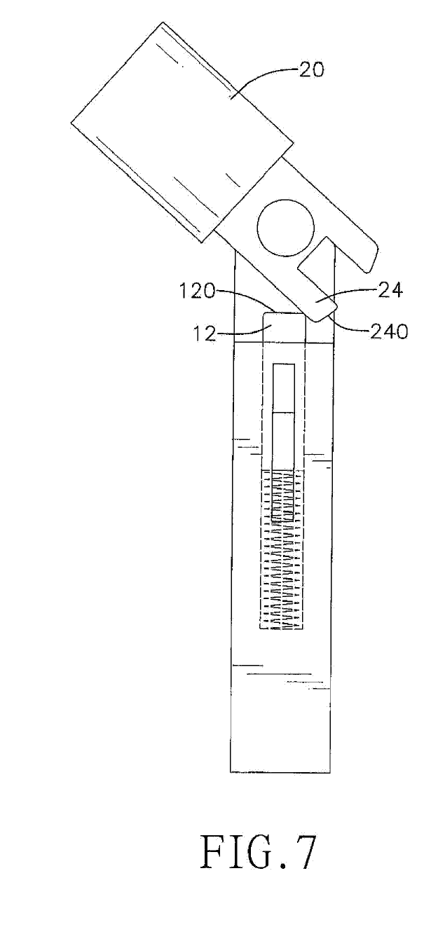

The pivoting bracket (20) is pivotally mounted on the extending portion (14) of the body (10), is cylindrical and has a front end, a rear end and a mounting portion (21). The rear end of the pivoting bracket (20) is selectively abutting one side edge of the extending portion (14) when the pivoting bracket is perpendicular relative to the body (10) to stop the pivoting bracket (20) from over-rotating and to support the pivoting bracket (20) in position. The mounting portion (21) protrudes from the rear end of the pivoting bracket (20) and has two sides, a rear end, a pivoting hole (210), a first tongue (23), a second tongue (24), a recess (230) and an abutting surface. The pivoting hole (210) is formed through the mounting portion (21) and corresponds to the through hole (140) of the extending portion (14) of the body (10). The tongues (23)(24) are axially and separately formed on the rear end of the mounting portion (21) and respectively have a slanted end (231)(240). The slanted end (231) of the first tongue (23) has a slope larger than the slanted end (240) of the second tongue (24) and allows the distal end (120) of the retaining element (12) to slide through the slope. On the other hand, with further reference to FIG. 7, The slanted end (240) of the second tongue (24) dose not allow the distal end (120) of the retaining element (12) to slide through the slope, so as to remind the user what is the correct rotating direction of the pivoting bracket (20). The recess (230) is defined between the tongues (23)(24) and selectively receives the distal end (120) of the retaining element (12) when the pivoting bracket (20) rotates relative to the body (10) to hold the pivoting bracket (20) upright relative to the body (10). The abutting surface is defined on one side of the mounting portion (21) and abuts the distal end (120) of the retaining element (12) when the pivoting bracket (20) rotates to a position perpendicular to the body (10) to provide an extra supporting effect to the pivoting bracket (20). The bolt (22) is mounted sequentially through the pivoting hole (210) of the mounting portion (21) and the through hole (140) of the extending portion (14) to pivotally mount the pivoting bracket (20) on the body (10).

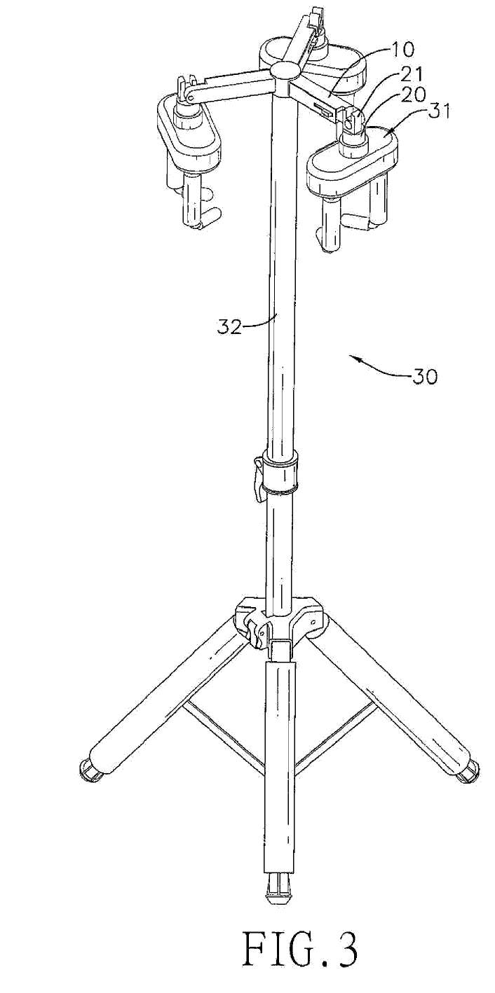

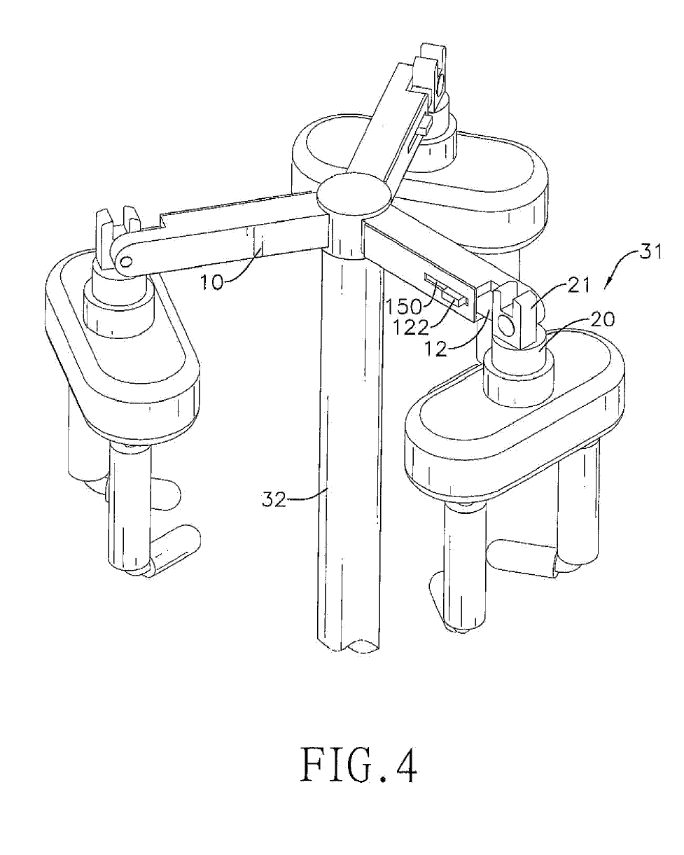

With reference to FIGS. 3 and 4, a music instrument stand (30) comprises multiple holder (31) and a stand (32). The stand (32) has a top, a bottom and multiple legs. The legs are formed radially from the bottom of the stand (32) and abut the ground to support the stand (32). Each holder (31) has a pair of hooks to clamp a music instrument and therefor holds the music instrument in position.

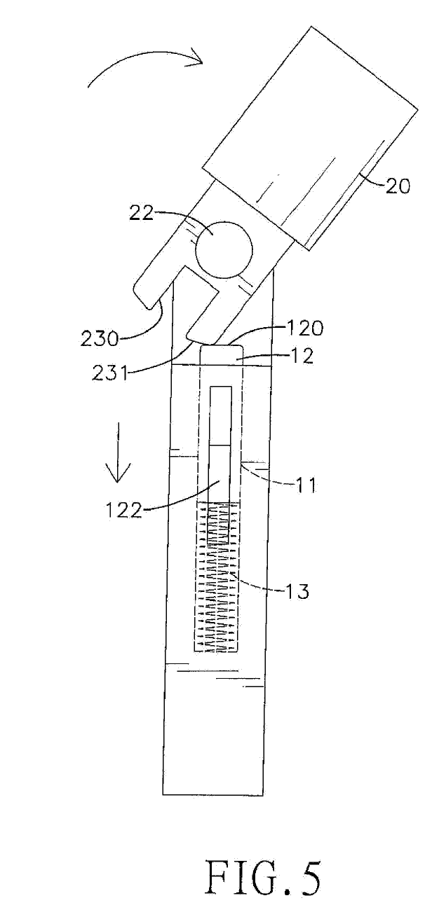

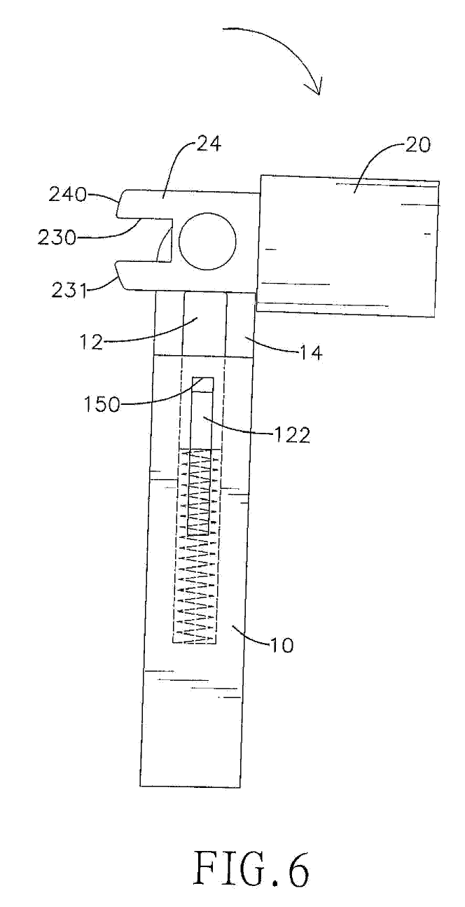

Multiple folding devices in accordance with the present invention are radially and securely mounted on the top of the stand (32) in a horizontal direction and the front end of the pivoting bracket (20) of each folding device connects securely to one of the holders (31). With further reference to FIGS. 5 and 6, with such an arrangement, when the music instrument stand (30) is transported, a user can fold the music instrument stand (30) by pushing the protrusion (122) of each folding device inward till the distal end (120) of the retaining element (12) disengage from the recess (230) of the pivoting bracket (20) and pivoting the holders (31) downward relative to the stand (32). Thus the instrument stand (30) may be in a folded manner and have a smaller volume to make instrument stand (30) be convenient transporting.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A folding device comprising
a body having
a side surface;
a top end;
a receiving notch being formed longitudinally in the side surface of the body and having an opening formed in the top end of the body;
an extending portion being longitudinally protruding from the top end of the body besides the opening of the receiving notch and having two side edges and
a resilient element being mounted longitudinally in the receiving notch and having two ends;
a retaining element being mounted inside the receiving notch near the opening and having
a side surface;
a proximal end abutting one end of the resilient element; and
a distal end protruding out from the opening of the receiving notch; and
a pivoting bracket being pivotally mounted on the extending portion of the body and having
a front end;
a rear end selectively abutting one side edge of the extending portion when the pivoting bracket being perpendicular relative to the body to abut the pivoting bracket;
a mounting portion protruding from the rear end of the pivoting bracket and having
two sides;
a rear end;
a first tongue and a second tongue being axially and separately formed on the rear end of the mounting portion and respectively have a slanted end;
a recess being defined between the tongues and being selectively receive the distal end of the retaining element when the pivoting bracket rotates relative to the body to hold the pivoting bracket upright relative to the body; and
an abutting surface being defined on one side of the mounting portion and selectively abutting the distal end of the retaining element.

2. The folding device as claimed in claim 1, wherein
the body further has a cover being mounted securely on the side surface of the body and having a slot being formed longitudinally through the cover, corresponding to the receiving notch and having a length; and
the retaining element of the body further has a protrusion being formed transversely on the side surface and extending through the slot in the cover.

3. The folding device as claimed in claim 2, wherein
the body further has a through hole formed transversely through the extending portion;
the pivoting bracket further has a pivoting hole being formed through the mounting portion and corresponding to the through hole of the extending portion of the body; and
the folding device further comprises a bolt being mounted sequentially through the pivoting hole of the mounting portion and the through hole of the extending portion of the body to pivotally mount the pivoting bracket on the body.
